(19) United States
(12) Patent Application Publication
(10) Pub. No.: US 2015/0259226 A1
(43) Pub. Date: Sep. 17, 2015

(54) DESALINATION APPARATUS

(71) Applicant: National Tsing Hua University, HSIN-CHU CITY (TW)

(72) Inventors: FAN-GANG TSENG, HSIN-CHU CITY (TW); JEN-KUEI WU, HSIN-CHU CITY (TW); CHIA-JUNG CHANG, HSIN-CHU CITY (TW); YU-LUN CHUEH, HSIN-CHU CITY (TW)

(21) Appl. No.: 14/644,854

(22) Filed: Mar. 11, 2015

(30) Foreign Application Priority Data
Mar. 11, 2014 (TW) 103108391

(51) Int. Cl. C02F 1/469

(52) U.S. Cl. CPC C02F 1/4695; C02F 2103/08

(57) ABSTRACT

This disclosure provides a desalination apparatus having a first electrode plate, a first filtering unit, a second filtering unit and a second electrode plate arranged in sequence as well as a power supply unit. Each of the filtering units comprising: an insulation substrate having a plurality of trench holes penetrating through the insulation substrate; a conductive layer formed on the insulation substrate and sidewalls of the plurality of trench holes; and an insulation layer formed on the conductive layer and the sidewalls of the plurality of trench holes; wherein the power supply unit provides the first filtering unit, the second filtering unit, the first electrode plate and the second electrode plate with a first electric potential of positive value, a second electric potential of negative value, a third electric potential and a fourth electric potential, respectively, and the third electric potential is larger than the fourth electric potential.

This application claims the benefit of Taiwan application Serial No. 103108391 filed Mar. 11, 2014, the disclosure of which is incorporated by reference herein in its entirety.

### TECHNICAL FIELD

The present disclosure relates to a desalination apparatus, and more particularly, to a desalination apparatus based on the electro-double-layer (EDL) overlap effect.

### TECHNICAL BACKGROUND

Desalination of the seawater has attracted an increasing interest since 1950. According to the International Desalination Association, more than 14,000 desalination plants operated worldwide in 2009, producing 59.9 million cubic meters (Mm³) per day, a yearly increase of 12.3%. The production was 68 Mm³ in 2010, and expected to reach 120 Mm³ by 2020. Many desalination techniques have been developed with varying degrees of success, such as multi-stage flash (MSF), multi-effect distillation (MED), vapor compression (VC), reverse Osmosis (RO), electro-dialysis (ED), and nano-filtration (NF). Due to relatively high energy consumption the cost of desalinating sea water are generally high. Therefore, it is in need to develop a new desalination technique.

### TECHNICAL SUMMARY

According to one aspect of the present disclosure, one embodiment provides a desalination apparatus having a first electrode plate, a first filtering unit, a second filtering unit and a second electrode plate arranged in sequence as well as a power supply unit, each of the filtering units comprising: an insulation substrate having a plurality of trench holes penetrating through the insulation substrate; a conductive layer formed on the insulation substrate and sidewalls of the plurality of trench holes; and an insulation layer formed on the conductive layer and the sidewalls of the plurality of trench holes; wherein the power supply unit provides the first filtering unit, the second filtering unit, the first electrode plate and the second electrode plate with a first electric potential of positive value, a second electric potential of negative value, a third electric potential and a fourth electric potential, respectively, and the third electric potential is larger than the fourth electric potential.

In one embodiment, the insulation substrate may have a thickness of between 40 and 200 μm and a porosity of between 25% and 50%.

In one embodiment, the insulation substrate may comprise an anodic-aluminum-oxide plate and the plurality of trench holes may have an aperture of between 100 and 300 nm.

In one embodiment, the conductive layer may comprise a metal film with a thickness of between 25 and 55 nm.

In one embodiment, the insulation layer may comprise hafnium oxide and have a thickness of between 5 and 35 nm.

In one embodiment, the first electric potential may be between 1 and 6.65 V and the second electric potential may be between −1 and −6.65 V.

In one embodiment, an electric field between the first electrode plate and the second electrode plate may be between 5.411 and 54.11 V/cm.

In one embodiment, the insulation substrate may comprise an anodic-aluminum-oxide plate with a thickness of 60 μm, an aperture of the plurality of trench holes may be about 200 nm, the conductive layer may comprise an aluminum film with a thickness of 50 nm, and the insulation layer may comprise a hafnium oxide layer with a thickness of 10 nm.

In one embodiment, the first electric potential may be about 1 V, the second electric potential may be about −1 V, an electric field between the first electrode plate and the second electrode plate may be larger than 5.411 V/cm.

In one embodiment, in the first filtering unit, the conductive layer may accumulate a plurality of first positive charges on its outer side face, and a plurality of second negative charges and second positive charges may be respectively induced on inner and outer side faces of the insulation layer, so that when a solution containing a plurality of positive ions and negative ions passes through the plurality of trench holes, the plurality of positive ions is repelled from side walls of the plurality of trench holes, the plurality of negative ions is attracted to side walls of the plurality of trench holes, and an electric field between the first electrode plate and the second electrode plate is used to move the plurality of negative ions to a first exit.

In one embodiment, in the second filtering unit, the conductive layer may accumulate a plurality of first negative charges on its outer side face, and a plurality of third positive charges and third negative charges may be respectively induced on inner and outer side faces of the insulation layer, so that when a solution containing a plurality of positive ions and negative ions passes through the plurality of trench holes, the plurality of negative ions is repelled from side walls of the plurality of trench holes, the plurality of positive ions is attracted to side walls of the plurality of trench holes, and an electric field between the first electrode plate and the second electrode plate is used to move the plurality of positive ions to a second exit.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 shows a cross-sectional view of a desalination apparatus according to one embodiment of the present disclosure.

FIG. 2 shows a perspective diagram of a filtering unit according to one embodiment of the present disclosure.

FIG. 3 shows a cross-sectional view of the filtering unit taken along the line A-A′ in FIG. 2.

FIGS. 4A to 4C show the distributions of the charges in the conductive layer 126 and the insulation layer as well as the ions in the trench holes at different electric potentials.

FIG. 5 shows the measured concentration of the NaCl solution processed by the desalination apparatus of the embodiment at different cycle times.

FIG. 6 shows the measured concentration of the NaCl solution processed by the desalination apparatus of a first case according to the solution flow.

FIG. 7 shows the measured concentration of the NaCl solution processed by the desalination apparatus of a second case according to the solution flow.

### DESCRIPTION OF THE EXEMPLARY EMBODIMENTS

For further understanding and recognizing the fulfilled functions and structural characteristics of the disclosure, several exemplary embodiments cooperating with detailed description are presented as the following. Reference will now be made in detail to the preferred embodiments, examples of which are illustrated in the accompanying drawings.

In the following description of the embodiments, it is to be understood that when an element such as a layer (film), region, pattern, or structure is stated as being “on” or “under” another element, it can be “directly” on or under another element or can be “indirectly” formed such that an intervening element is also present. Also, the terms such as “on” or “under” should be understood on the basis of the drawings, and they may be used herein to represent the relationship of one element to another element as illustrated in the figures. It will be understood that this expression is intended to encompass different orientations of the elements in addition to the orientation depicted in the figures, namely, to encompass both “on” and “under”. In addition, although the terms “first”, “second” and “third” are used to describe various elements, these elements should not be limited by the term. Also, unless otherwise defined, all terms are intended to have the same meaning as commonly understood by one of ordinary skill in the art.

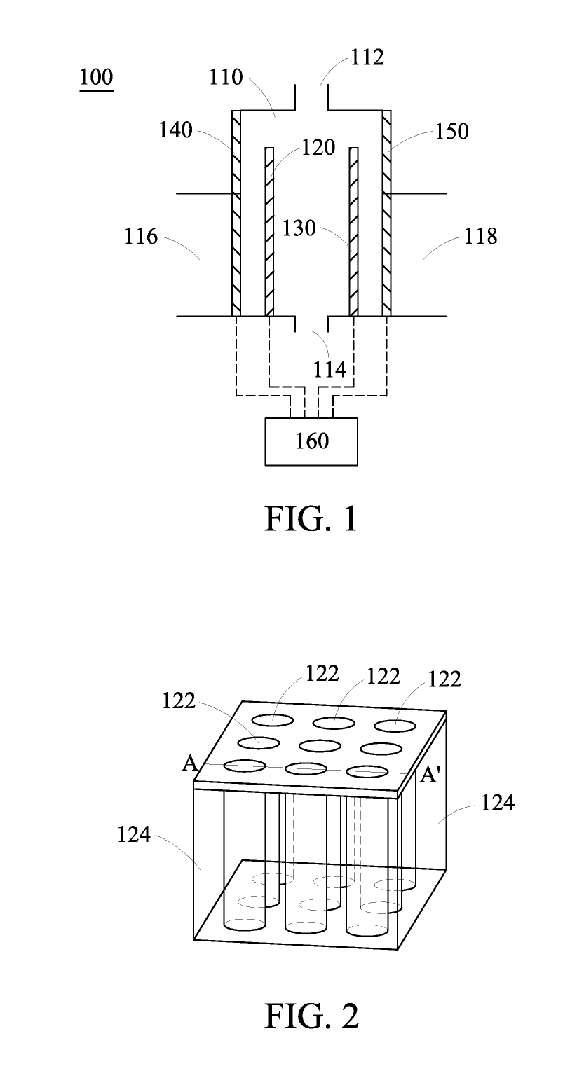

FIG. 1 schematically shows a cross-sectional view of a desalination apparatus 100 according to one embodiment of the present disclosure. The desalination apparatus 100 is used to remove or decrease salt and other minerals from saline water or seawater. Salt is an ionic compound, and it separates into positive ions (or ions with a positive charge) and negative ions (or ions with a negative charge) when dissolved in water. Here, desalination or desalinization refers to a process that removes or filters out some amount of positive ions and negative ions in salt water, to produce fresh water suitable for human consumption. Since sodium chloride (NaCl) is the salt most responsible for the salinity of the seawater, NaCl solution is used as the saline water or seawater in the embodiment to be desalinated. The desalination apparatus 100 is to remove Na⁺ and Cl⁻ ions or to decrease NaCl concentration in the NaCl solution; but is not limited thereto; it can be used to treat other salts or minerals in the saline water or seawater.

As shown in FIG. 1, the desalination apparatus 100 includes: a reaction chamber 110, a first filtering unit 120, a second filtering unit 130, a first electrode plate 140, a second electrode plate 150, and a power supply unit 160. The reaction chamber 110 may have one inlet 112 and three exits 114, 116 and 118. The saline water or seawater can be injected into the reaction chamber 110 through the inlet 112, the filtered positive ions (e.g., Na⁺) and negative ions (e.g., Cl⁻) are expelled from the reaction chamber 110 through the first exit 116 and the second exit 118, respectively, and the third exit 114 is designed to output the treated saline water or seawater. The first electrode plate 140, the first filtering unit 120, the second filtering unit 130 and the second electrode plate 150 may be disposed in sequence and arranged in parallel in the reaction chamber 110; but is not limited thereto, the first electrode plate 140, the first filtering unit 120, the second filtering unit 130 and the second electrode plate 150 may not parallel with each other. The power supply unit 160 is used to provide the first filtering unit 120, the second filtering unit 130, the first electrode plate 140 and the second electrode plate 150 with electric potentials or voltages.

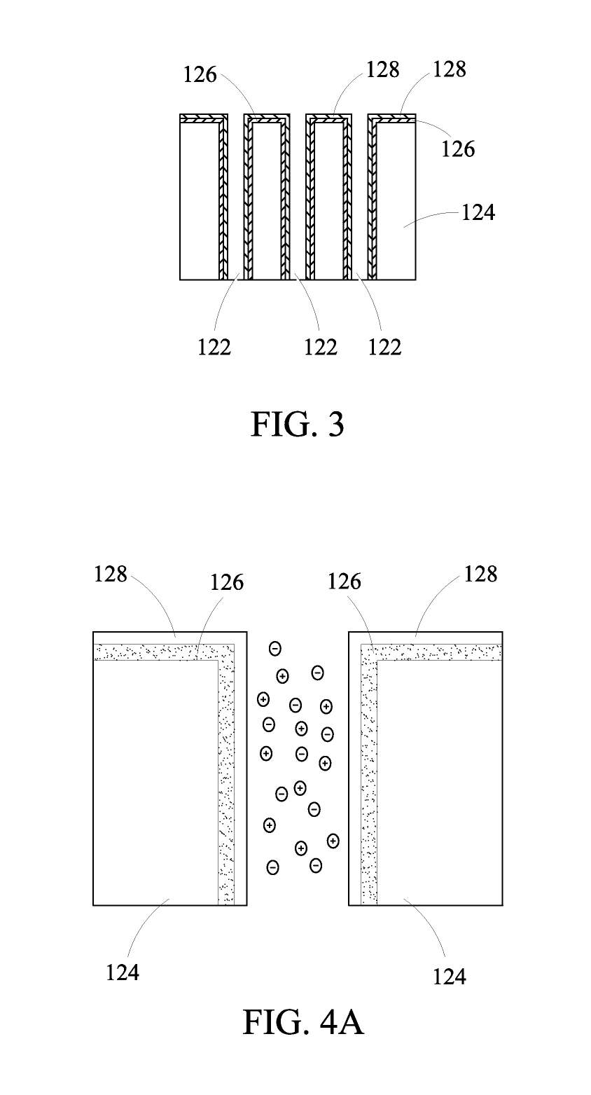

After the saline water or seawater flows into the reaction chamber 110, the first filtering unit 120 and the second filtering unit 130 are to perform the filtering of the negative and positive ions, respectively. In the embodiment, the first filtering unit 120 and the second filtering unit 130 have the same structure, but they are provided with different electric potentials or voltages according to what kind of ions they are going to treat. FIG. 2 schematically shows a perspective diagram of a filtering unit 120 or 130 according to one embodiment of the present disclosure, and FIG. 3 shows a cross-sectional view of the filtering unit 120 or 130 taken along the line A-A′ in FIG. 2. As shown in FIGS. 2 and 3, the filtering unit 120 or 130 may include: an insulation substrate 124 having a plurality of trench holes 122, a conductive layer 126 formed on the insulation substrate 124 and sidewalls of the plurality of trench holes 122, and an insulation layer 128 formed on the conductive layer 126 and the sidewalls of the plurality of trench holes 122. Wherein, the trench holes 122 may penetrate through the insulation substrate 124.

The insulation substrate 124 may be made of porous material, and a less thickness may facilitate the effect on filtering or removing the ions. However, regarding the mechanical strength, the insulation substrate 124 may tend to deformation or break due to the insufficient thickness. The conductive layer 126 may be made of electrically conductive material, e.g. metal, and its thickness can be designated according to the required electrical conductivity and mechanical strength. The insulation layer 128 may be made of high permittivity dielectric material, and a less thickness may facilitate the dielectric polarization effect. However, regarding the mechanical strength, the insulation layer 128 may tend to generation of defects like a crack or hole due to the insufficient thickness. To affect the ion distributions of the saline water in the reaction chamber 110, a positive or negative electric potential is applied to the conductive layer 126. The electric potential would drive the ions into the trench holes 122, so the ions can be filtered out from the saline water. A metal thin film with good conductivity is suitable for the conductive layer 126, and a porous-material plate is suitable for the insulation substrate 124. For example, the insulation substrate 124 may be a porous insulation plate with a thickness of between 40 and 200 μm and a porosity of between 25% and 50%. In the embodiment, we choose an anodic-aluminum-oxide (AAO) plate as the insulation substrate 124; wherein, the AAO plate has trench holes 122 with an aperture of between 100 and 300 nm, a metal (e.g. aluminum (Al)) film with a thickness of between 25 and 55 nm as the conductive layer 126, a hafnium oxide (HfO₂) layer with a thickness of between 5 and 35 nm as the insulation layer 128. Breakdown voltage of the HfO₂ layer may increase about 1.9 V per 1-nm thickness increment.

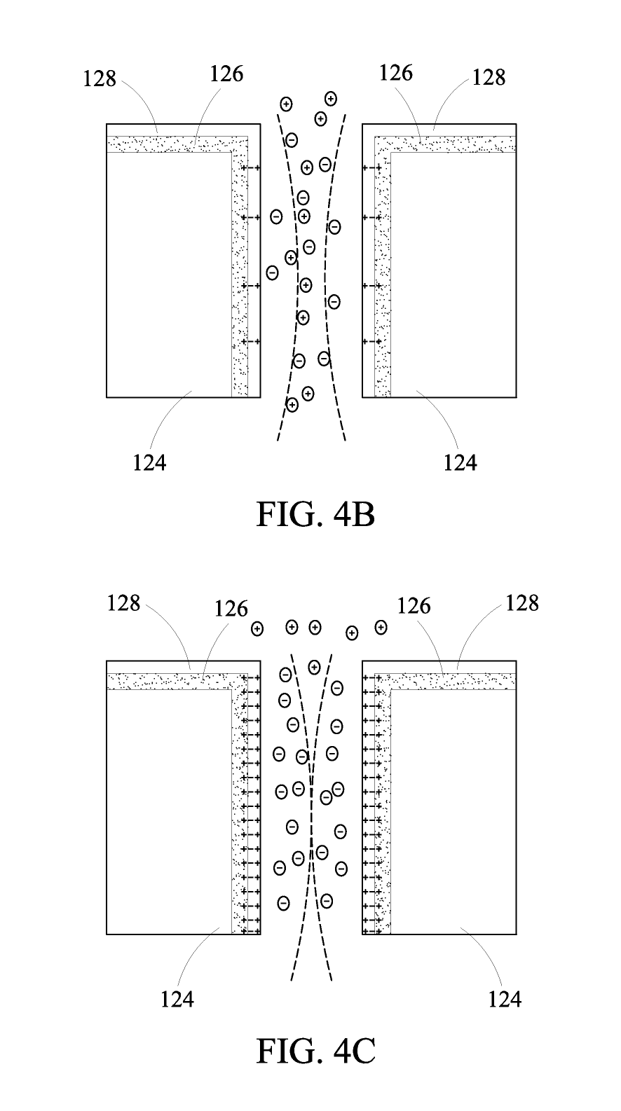

In the following paragraph, we explain the operational principle of the filtering unit 120 or 130. When the saline water of high concentration reaches the filtering unit 120 or 130, the distributions of positive and negative ions of the saline water in the trench holes 122 may be altered according to the electric potential of the conductive layer 126. In cases that different electric potentials are respectively applied to the filtering unit 120 or 130, the distributions of the charges in the conductive layer 126 and the insulation layer 128 as well as the ions in the trench holes 122 can be illustrated in FIG. 4 schematically. FIG. 4A shows the distribution of charges and ions when a zero electric potential is applied to the filtering unit 120 or 130. There is no charges accumulating in the conductive layer 126 and the insulation layer 128, and the positive and negative ions may distribute uniformly in the trench holes 122. FIG. 4B shows the distribution of charges and ions when a small positive potential is applied to the filtering unit 120 or 130. A small amount of positive charges may accumulate on the outer side face of the conductive layer 126, and a small amount of negative and positive charges may be respectively induced on the inner and outer side faces of the insulation layer 128. Thus, the positive ions in the saline water may be repelled away from the side walls of the trench holes 122, and the negative ions in the saline water may be attracted close to the side walls of the trench holes 122. This can be recited as the “electro-double-layer (EDL)” phenomena in the art. As shown in FIG. 4B, the dashed lines represent the boundaries between the distributions of the positive and negative ions, and the left and right boundaries are spaced out apart from each other. The effect of the EDL phenomena can be controlled by the electric potential applied to the conductive layer 126. As the electric potential increases, the separation between the two boundaries decreases. When a large positive electric potential is applied to the filtering unit 120 or 130, a large amount of positive charges may accumulate on the outer side face of the conductive layer 126, and a large amount of negative and positive charges may be respectively induced on the inner and outer side faces of the insulation layer 128. Thus, more positive ions in the saline water may be repelled away from the side walls of the trench holes 122, and more negative ions in the saline water may be attracted close to the side walls of the trench holes 122. The boundaries between the distributions of the positive and negative ions may get closer, meet, and even overlap with each other, as shown in FIG. 4C. This is the so-called “EDL overlap” phenomena in the art. Wherein, the positive ions cannot pass through the trench holes 122, but only the negative ions can be driven to pass through the trench holes 122 and be filtered out by the filtering unit 120 or 130.

On the other respect, if a negative electric potential is applied to the filtering unit 120 or 130, the distributions of the charges therein may very similar to those in

FIGS. 4B and 4C except that any of the “+” signs is switched to a “−” sign and any of the “−” signs is switched to a “+” sign. Thus, when a sufficient negative electric potential is applied to the filtering unit 120 or 130, the negative ions cannot pass through the trench holes 122, but only the positive ions can be driven to pass through the trench holes 122 and be filtered out by the filtering unit 120 or 130.

In the embodiment, we set the power supply unit 160 to provide the first filtering unit 120 with a first electric potential of positive value and the second filtering unit 130 with a second electric potential of negative value, so that the first filtering unit 120 is used to filter out the negative ions in the saline water or seawater and the second filtering unit 130 to filter the positive ions out. For example, the first electric potential can be set in a range between 1 and 6.65 V, and the second electric potential can be set in a range between −1 and −6.65 V. In other words, the filtering unit 120 or 130 may function as an ion selector, in which the first filtering unit 120 can select and extract negative ions in the saline water due to the positive electric potential, and the second filtering unit 130 is for positive ions due to the negative electric potential.

In the above-described operation of the filtering unit 120 or 130, the first filtering unit 120 and the second filtering unit 130 filter out negative ions and positive ions, respectively. However, when the ions pass through the trench holes 122, they tend to being adsorbed onto the side walls of the trench holes 122. The ions may accumulate on the side walls to block up the trench holes 122. Therefore, an electric field is further established across the reaction chamber 110 to drive the filtered negative ions in the first filtering unit 120 to move leftward and the filtered positive ions in the second filtering unit 130 to move rightward. The negative ions from the first filtering unit 120 are then evacuated to the first exit 116 and the positive ions from the second filtering unit 130 are evacuated to the second exit 118. The operation is described in detail in the following paragraphs.

By applying a third electric potential to the first electrode plate 140 and a fourth electric potential less than the third electric potential to the second electrode plate 150, the electric field can be established in a direction from the first electrode plate 140 to the second electrode plate 150. So, the negative ions filtered by the first filtering unit 120 keep moving leftward to the first exit 116, and the positive ions filtered by the second filtering unit 130 keep moving rightward to the second exit 118.

For example, the electric field between the first electrode plate 140 and the second electrode plate 150 may have a magnitude between 5.411 and 54.11 V/cm.

In an exemplary embodiment, the desalination apparatus 100 is based on AAO material. An AAO plate with a thickness of 60 μm was used as the insulation substrate 124, wherein the trench holes 122 have an aperture of about 200 nm. An Al film with a thickness of 50 nm was deposited on the insulation substrate 124 as well as the sidewalls of the trench holes 122 to act as the conductive layer 126. An HfO₂ film with a thickness of 10 nm was then deposited on the conductive layer 126 as well as the sidewalls of the trench holes 122 to be the insulation layer 128. An electric potential of about 1 V was applied to the first filtering unit 120, another electric potential of about −1 V was applied to the second filtering unit 130, and a potential difference of about 1500 V was applied between the first electrode plate 140 and the second electrode plate 150. The housing or outer case of the reaction chamber 110 is made of acrylic material with a relative dielectric constant of 4, and the saline water has a relative dielectric constant of about 80. The housing has a thickness of 0.65 cm and the reaction chamber 110 has a waist width of 1.7 cm.

Although the 1500V voltage was applied between the first electrode plate 140 and the second electrode plate 150, only 92 V is effectively sensed by the saline water, and the remainder 1408 V may be taken away by the acrylic material of the housing to be an ineffective voltage. Thus, only an electric field of about 54.11 V/cm has an effect on the positive and negative ions in the reaction chamber 110. The electric field may drive the filtered negative ions in the first filtering unit 120 to move leftward into the first exit 116 and the filtered positive ions in the second filtering unit 130 to move rightward into the second exit 118. Hence, the adsorption and accumulation of the ions on the side walls of the trench holes 122 can be prevented so that the ions can be evacuated from the trench holes 122.

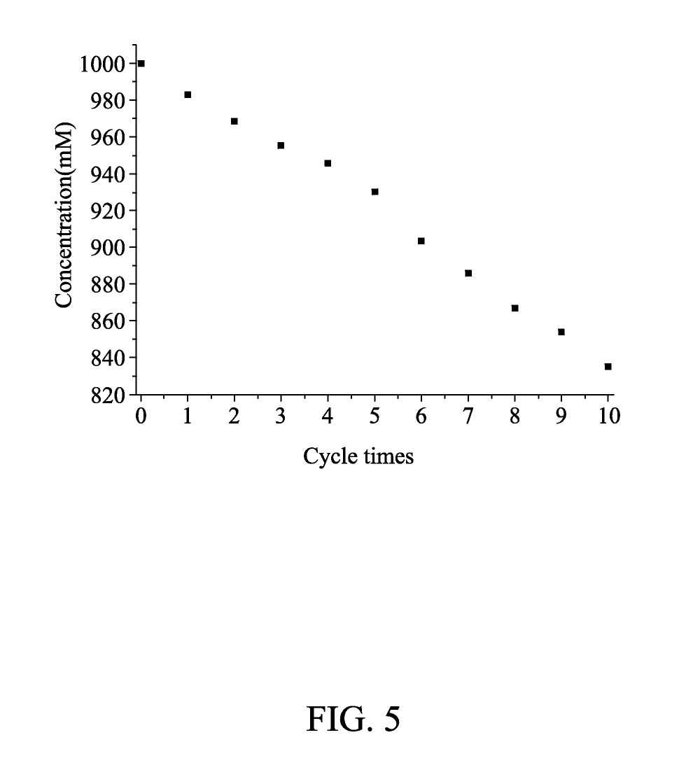

Moreover, to improve the desalination performance, the desalination apparatus 100 can be designed to construct a circulative feedback system. For example, the third exit 114 can be connected to the inlet 112, so that the treated saline water outputted from the third exit 114 of the desalination apparatus 100 can be fed back into the inlet 112 of the desalination apparatus 100 circulatively. To verify the desalination performance of the circulative desalination apparatus 100, a 1M (or 1000 mM) NaCl solution is injected into the device. FIG. 5 shows the measured concentration of the NaCl solution processed by the desalination apparatus 100 of the embodiment at different cycle times. As shown in FIG. 5, the concentration of the NaCl solution can be decreased to 835.08 mM, corresponding to a desalination efficiency of 16.5%, after ten cycles of desalination.

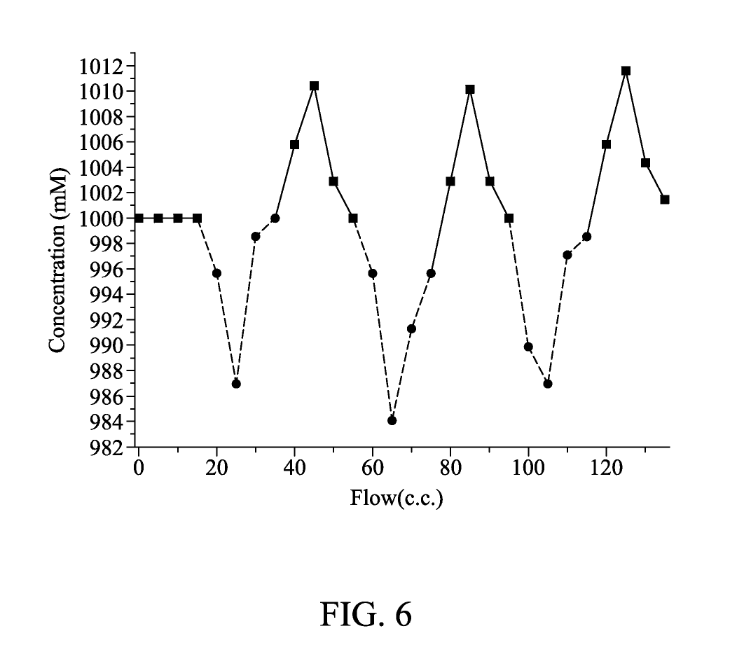

Consider the case that only the electric potentials of 1V and −1V are respectively applied to the first filtering unit 120 and the second filtering unit 130, with no voltage application between the first electrode plate 140 and the second electrode plate 150. That is to say, only the filtering units 120 and 130 affect the input saline water. After injecting a 1000 mM NaCl solution into the desalination apparatus 100, we measured the concentration of the output NaCl solution at the third exit 114. As the dashed-line curve shows in FIG. 6, the concentration would go down to a minimum (e.g. 984 mM) and then go up back to 1000 mM. This is because the ion adsorption of the filtering units 120 and 130 may have been saturated at the minimum, and the concentration increases reversely after that. At this moment, if the electric potentials are switched off, the concentration would go up to a maximum (e.g. 1010 mM) and then go down back to 1000 mM, as the solid-line curve shows in FIG. 6. The reason for the concentration increment comes from the fact that the adsorbed ions on the filtering units 120 and 130 may depart back to the NaCl solution after the electric potentials are switched off. FIG. 6 shows the measured concentration of the NaCl solution processed by the desalination apparatus 100 of this case according to the solution flow. The results indicate that the filtering units 120 and 130 can adsorb ions in the NaCl solution to decrease its concentration, when positive and negative potentials are respectively applied to the first filtering unit 120 and the second filtering unit 130. However, the ion adsorbability of the filtering units 120 and 130 would saturate, and the saturation would limit the desalination efficiency of the desalination apparatus 100.

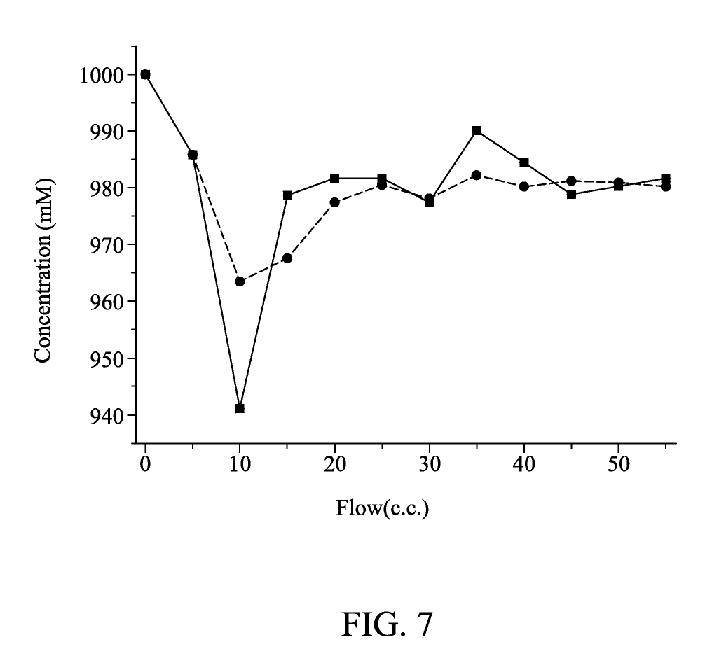

Next, consider the case that the electric potentials of 1V and −1V are respectively applied to the first filtering unit 120 and the second filtering unit 130, and an electric voltage of 1500V applied between the first electrode plate 140 and the second electrode plate 150. After injecting a 1000 mM NaCl solution into the desalination apparatus 100, we measured the concentration of the output NaCl solution at the third exit 114. FIG. 7 shows the measured concentration of the NaCl solution processed by the desalination apparatus 100 of this case according to the solution flow. Wherein, the solid-line curve represents the concentration measurement of the NaCl solution for every 5 c.c. solution flow, and the dashed-line curve represents cumulative measurement results for the NaCl solution. It should be noted that too much ion adsorption on the filtering units 120 and 130 would cause a loss in measurement accuracy, and this can be avoided by the above-mentioned every-5 c.c.-flow measurement. As shown in FIG. 7, the concentration of the NaCl solution can be reduced from 1000 mM to 941.13 mM at the flow of 10 c.c. after treated by the desalination apparatus 100. The desalination efficiency is estimated to be 5.9%. Also, the desalination apparatus 100 has an average desalination capacity to reduce concentration of the NaCl solution from 1000 mM to 981 mM, which corresponds to a desalination efficiency of 5.9%.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A desalination apparatus having a first electrode plate, a first filtering unit, a second filtering unit and a second electrode plate arranged in sequence as well as a power supply unit, each of the filtering units comprising:
an insulation substrate having a plurality of trench holes penetrating through the insulation substrate;
a conductive layer formed on the insulation substrate and sidewalls of the plurality of trench holes; and
an insulation layer formed on the conductive layer and the sidewalls of the plurality of trench holes;
wherein the power supply unit provides the first filtering unit, the second filtering unit, the first electrode plate and the second electrode plate with a first electric potential of positive value, a second electric potential of negative value, a third electric potential and a fourth electric potential, respectively, and the third electric potential is larger than the fourth electric potential.

2. The desalination apparatus according to claim 1, wherein the insulation substrate has a thickness of between 40 and 200 μm and a porosity of between 25% and 50%.

3. The desalination apparatus according to claim 2, wherein the insulation substrate comprises an anodic-aluminum-oxide plate and the plurality of trench holes have an aperture of between 100 and 300 nm.

4. The desalination apparatus according to claim 1, wherein the conductive layer comprises a metal film with a thickness of between 25 and 55 nm.

5. The desalination apparatus according to claim 1, wherein the insulation layer comprises hafnium oxide (HfO₂) and has a thickness of between 5 and 35 nm.

6. The desalination apparatus according to claim 1, wherein the first electric potential is between 1 and 6.65 V.

7. The desalination apparatus according to claim 1, wherein the second electric potential is between −1 and −6.65 V.

8. The desalination apparatus according to claim 1, wherein an electric field between the first electrode plate and the second electrode plate is between 5.411 and 54.11 V/cm.

9. The desalination apparatus according to claim 1, wherein the insulation substrate comprises an anodic-aluminum-oxide plate with a thickness of 60 μm, an aperture of the plurality of trench holes is about 200 nm, the conductive layer comprises an aluminum (Al) film with a thickness of 50 nm, and the insulation layer comprises a hafnium oxide (HfO₂) layer with a thickness of 10 nm.

10. The desalination apparatus according to claim 9, wherein the first electric potential is about 1 V, the second electric potential is about −1 V, an electric field between the first electrode plate and the second electrode plate is larger than 5.411 V/cm.

11. The desalination apparatus according to claim 1, wherein, in the first filtering unit, the conductive layer accumulates a plurality of first positive charges on its outer side face, and a plurality of second negative charges and second positive charges are respectively induced on inner and outer side faces of the insulation layer, so that when a solution containing a plurality of positive ions and negative ions passes through the plurality of trench holes, the plurality of positive ions is repelled from side walls of the plurality of trench holes, the plurality of negative ions is attracted to side walls of the plurality of trench holes, and an electric field between the first electrode plate and the second electrode plate is used to move the plurality of negative ions to a first exit.

12. The desalination apparatus according to claim 1, wherein, in the second filtering unit, the conductive layer accumulates a plurality of first negative charges on its outer side face, and a plurality of third positive charges and third negative charges are respectively induced on inner and outer side faces of the insulation layer, so that when a solution containing a plurality of positive ions and negative ions passes through the plurality of trench holes, the plurality of negative ions is repelled from side walls of the plurality of trench holes, the plurality of positive ions is attracted to side walls of the plurality of trench holes, and an electric field between the first electrode plate and the second electrode plate is used to move the plurality of positive ions to a second exit.
